(19) United States
(12) Patent Application Publication
(10) Pub. No.: US 2010/0066291 A1
(43) Pub. Date: Mar. 18, 2010

(54) METHOD AND MODULE FOR CONTROLLING ROTATION OF A MOTORIZED SPINDLE

(75) Inventors: Paul Chang, Taichung County (TW); Tsair-Rong Chen, Changhua County (TW); Jeen-Sheen Row, Miaoli County (TW); Chin-Sheng Lu, Taichung County (TW)

Correspondence Address: KNOBBE MARTENS OLSON & BEAR LLP, 2040 MAIN STREET, FOURTEENTH FLOOR, IRVINE, CA, 92614, US

(73) Assignees: Buffalo Machinery Co., Ltd., Daya Township (TW); Department of Electrical Engineering, National Chang-Hua University of Education, Changhua City (TW)

(21) Appl. No.: 12/233,475

(22) Filed: Sep. 18, 2008

(51) Int. Cl. H02P 23/04

(52) U.S. Cl. 318/460

(57) ABSTRACT

In a method and module for controlling rotation of a motorized spindle driven by a driving unit, a sensing unit is adapted for sensing vibration of the spindle and generates a voltage signal corresponding to the vibration of the spindle. A processing unit is coupled to the sensing unit for receiving the voltage signal therefrom, and outputs a control signal corresponding to the voltage signal upon detecting that the voltage signal is greater than a reference voltage corresponding to a predetermined vibration level of the spindle, such that the driving unit adjusts a rotation speed of the spindle in response to the control signal from the processing unit.

### BACKGROUND OF THE INVENTION

1. Field of the Invention

The invention relates to a method and module for controlling rotation of a motorized spindle.

2. Description of the Related Art

Vibration of high-speed spindles is considered a main cause of damage to such spindles.

Referring to FIG. 1, a conventional driving device 1 for a motorized spindle 2 is shown to include a detecting unit 11, and a driving unit 12 for driving the spindle 2. The detecting unit 11 generates a detecting signal upon detecting that vibration of the spindle 2 is greater than a predetermined vibration level, and outputs the detecting signal to the driving unit 12. The driving unit 12 stops driving the spindle 2 or reduces a rotation speed of the spindle 2 in accordance with the detecting signal from the detecting unit 11.

In such a driving device 1, it is important to appropriately decide the predetermined vibration level of the spindle 2. For example, if the predetermined vibration level of the spindle 2 is relatively high, the spindle 2 has been subjected to damaging vibration levels for a long period before the detecting unit 11 outputs the detecting signal to the driving unit 12, thereby reducing the service life of the spindle 2. On the other hand, if the predetermined vibration level of the spindle 2 is relatively low, the driving unit 12 reduces the rotation speed of the spindle 2 or stops driving the spindle 2, frequently, thereby adversely affecting transmission efficiency of the spindle 2.

### SUMMARY OF THE INVENTION

Therefore, an object of the present invention is to provide a method and module for controlling rotation of a motorized spindle that can overcome the aforesaid drawbacks of the prior art.

According to one aspect of the present invention, there is provided a method of controlling rotation of a motorized spindle. The method comprises the steps of:

a) sensing vibration of the spindle;

b) generating a voltage signal corresponding to the vibration of the spindle;

c) determining whether the voltage signal generated in step b) is greater than a reference voltage corresponding to a predetermined vibration level of the spindle; and

d) adjusting a rotation speed of the spindle in accordance with the voltage signal generated in step b) upon detecting that the voltage signal generated in step b) is greater than the reference voltage.

According to another aspect of the present invention, there is provided a module for controlling rotation of a motorized spindle driven by a driving unit to rotate at a rotation speed. The module comprises:

a sensing unit adapted for sensing vibration of the spindle and for generating a voltage signal corresponding to the vibration of the spindle; and

a processing unit coupled to the sensing unit for receiving the voltage signal generated thereby, and outputting a control signal corresponding to the voltage signal generated by the sensing unit upon detecting that the voltage signal generated by the sensing unit is greater than a reference voltage corresponding to a predetermined vibration level of the spindle, such that the driving unit adjusts the rotation speed of the spindle in response to the control signal from the processing unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of a conventional driving device for a motorized spindle;

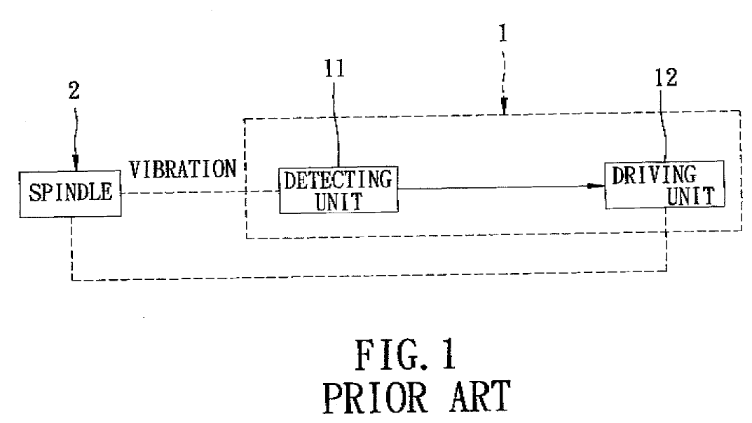

FIG. 2 is a flowchart illustrating the preferred embodiment of a method of controlling rotation of a motorized spindle according to the present invention; and

FIG. 3 is a schematic circuit block diagram illustrating a module for performing the method of the preferred embodiment.

### DETAILED DESCRIPTION OF THE PREFERRED EMBODIMENT

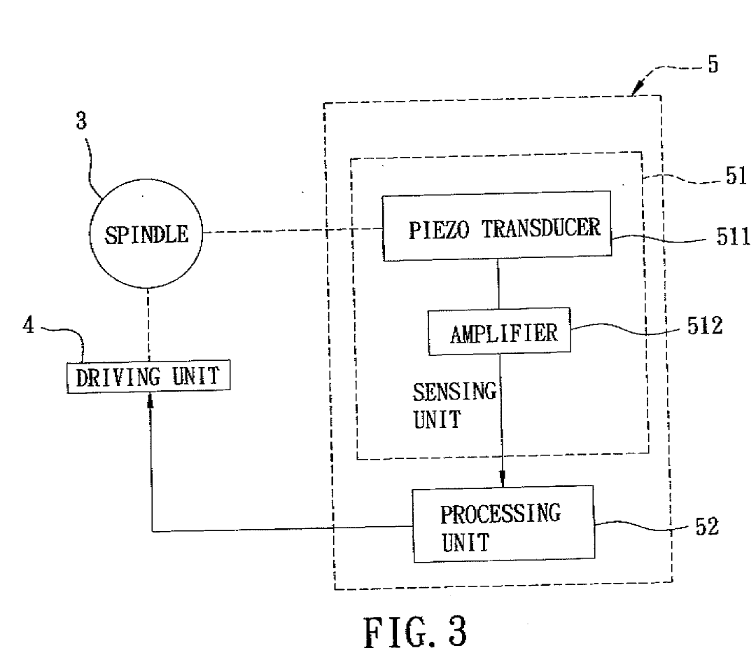

Referring to FIG. 3, a module 5 for performing the preferred embodiment of a method of controlling rotation of a motorized spindle 3 according to the present invention is shown to include a sensing unit 51 and a processing unit 52. The spindle 3 is driven by a driving unit 4 to rotate at a rotation speed.

The sensing unit 51 is adapted for sensing vibration of the spindle 3, and generates a voltage signal corresponding to the vibration of the spindle 3. In this embodiment, the sensing unit 51 includes a piezo transducer 511 for sensing the vibration of the spindle 3 and for generating a voltage output in response to the vibration of the spindle 3, and an amplifier 512 (e.g., an operational amplifier) coupled to the piezo transducer 511 for amplifying the voltage output to result in the voltage signal.

The processing unit 52 is coupled to the amplifier 512 of the sensing unit 51 for receiving the voltage signal generated by the sensing unit 51, and is adapted to output, to the driving unit 4, a control signal corresponding to the voltage signal generated by the sensing unit 51 upon detecting that the voltage signal generated by the sensing unit 51 is greater than a reference voltage corresponding to a predetermined vibration level of the spindle, such that the driving unit 4 adjusts the rotation speed of the spindle 3 in response to the control signal from the processing unit 52. In this embodiment, the predetermined vibration level of the spindle 4 is equal to 2 mm/sec, and the reference voltage is 2 volts. When the voltage signal generated by the sensing unit 51 is not smaller than a threshold voltage that is greater than the reference voltage, the control signal from the processing unit 52 causes the driving unit 4 to stop driving the spindle 3. In this embodiment, the threshold voltage is 4 volts. When the voltage signal generated by the sensing unit 51 is within a range from the reference voltage to the threshold voltage, the control signal from the processing unit 52 causes the driving unit 4 to reduce the rotation speed of the spindle 3.

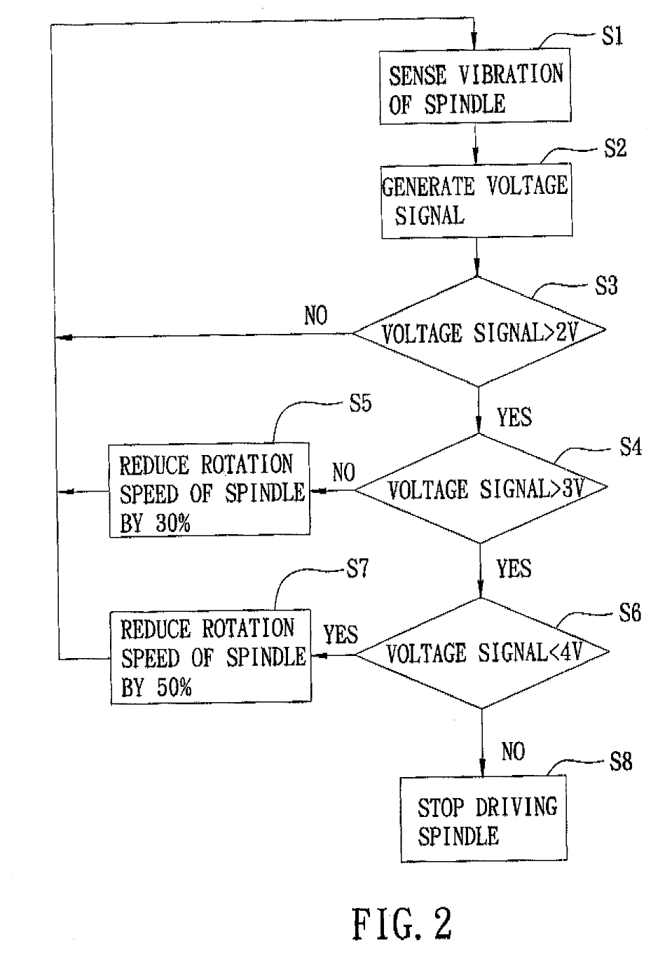

Referring to FIG. 2, there is shown a flowchart to illustrate the method of the preferred embodiment. In step S1, the piezo transducer 511 of the sensing unit 51 senses the vibration of the spindle 3 and generates the voltage output in response to the vibration of the spindle 3. In step S2, the amplifier 512 of the sensing unit 51 amplifies the voltage output to generate the voltage signal. In step S3, the processing unit 52 determines whether the voltage signal is greater than 2 volts, i.e., the reference voltage. If negative, the flow goes back to step S1. In this case, the rotation speed of the spindle 3 remains unchanged. When it is determined in step S3 that the voltage signal is greater than 2 volts, the processing unit 52 outputs the control signal corresponding to the voltage signal to the driving unit 4, and the flow proceeds to step S4. In step S4, the processing unit 52 determines whether the voltage signal is greater than 3 volts. If negative, the flow goes to step S5. Otherwise, the flow goes to step S6. In step S5, the control signal from the processing unit 52 causes the driving unit 4 to reduce the rotation speed of the spindle 3 by 30%. Then, the flow goes back to step S1. In step S6, the processing unit 52 determines whether the voltage signal is smaller than 4 volts, i.e., the threshold voltage. If affirmative, the flow goes to step S7. Otherwise, the flow proceeds to step S8. In step S7, the control signal from the processing unit 52 causes the driving unit 4 to reduce the rotation speed of the spindle 3 by 50%, and the flow goes back to step S1. In step S8, the control signal from the processing unit 52 causes the driving unit 4 to stop driving the spindle 3.

In sum, the module 5 can appropriately control the rotation speed of the spindle 3 when the vibration of the spindle 3 is greater than the predetermined vibration level. Thus, the service life of the spindle 3 can be prolonged, and shutdown frequency of the spindle 3 can be minimized.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method of controlling rotation of a motorized spindle, comprising the steps of:
a) sensing vibration of the spindle;
b) generating a voltage signal corresponding to the vibration of the spindle;
c) determining whether the voltage signal generated in step b) is greater than a reference voltage corresponding to a predetermined vibration level of the spindle; and
d) adjusting a rotation speed of the spindle in accordance with the voltage signal generated in step b) upon detecting that the voltage signal generated in step b) is greater than the reference voltage.

2. The method as claimed in claim 1, wherein the predetermined vibration level of the spindle is equal to 2 mm/sec, and the reference voltage is 2 volts.

3. The method as claimed in claim 1, wherein, in step d), the rotation speed of the spindle is adjusted to be zero when the voltage signal generated in step b) is not smaller than a threshold voltage that is greater than the reference voltage.

4. The method as claimed in claim 3, wherein the threshold voltage is 4 volts.

5. The method as claimed in claim 3, wherein, in step d), the rotation speed of the spindle is reduced when the voltage signal generated in step b) is within a range from the reference voltage to the threshold voltage.

6. The method as claimed in claim 5, wherein the reference voltage is 2 volts, and the threshold voltage is 4 volts.

7. A module for controlling rotation of a motorized spindle driven by a driving unit to rotate at a rotation speed, said module comprising:
a sensing unit adapted for sensing vibration of the spindle and for generating a voltage signal corresponding to the vibration of the spindle; and
a processing unit coupled to said sensing unit for receiving the voltage signal generated thereby, and outputting a control signal corresponding to the voltage signal generated by said sensing unit upon detecting that the voltage signal generated by said sensing unit is greater than a reference voltage corresponding to a predetermined vibration level of the spindle, such that the driving unit adjusts the rotation speed of the spindle in response to the control signal from said processing unit.

8. The module as claimed in claim 7, wherein the predetermined vibration level of the spindle is equal to 2 mm/sec, and the reference voltage is 2 volts.

9. The module as claimed in claim 7, wherein the control signal from said processing unit causes the driving unit to stop driving the spindle when the voltage signal generated by said sensing unit is not smaller than a threshold voltage that is greater than the reference voltage.

10. The module as claimed in claim 9, wherein the threshold voltage is 4 volts.

11. The module as claimed in claim 9, wherein the control signal from said processing unit causes the driving unit to reduce the rotation speed of the spindle when the voltage signal generated by said sensing unit is within a range from the reference voltage to the threshold voltage.

12. The module as claimed in claim 11, wherein the reference voltage is 2 volts, and the threshold voltage is 4 volts.

13. The module as claimed in claim 7, wherein said sensing unit includes a piezo transducer for generating a voltage output in response to the vibration of the spindle, and an amplifier for amplifying the voltage output to result in the voltage signal.
